(19) United States
(12) Patent Application Publication
(10) Pub. No.: US 2007/0083351 A1
(43) Pub. Date: Apr. 12, 2007

(54) Integrated circuit test simulator

(75) Inventors: Gilles Van Assche, Bruxelles (BE); Jean-Louis Modave, Ottignies (BE)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: Proton World International N.V., Zaventem (BE)

(21) Appl. No.: 11/546,509

(22) Filed: Oct. 11, 2006

(30) Foreign Application Priority Data
Oct. 12, 2005 (FR) 05/53105

(51) Int. Cl. G06F 17/50

(52) U.S. Cl. 703/14

(57) ABSTRACT

A method and a simulator for testing an electronic circuit by parallel execution of a program in the circuit and in a simulator, including a step of checking that commands and conditions contained in the simulator have effectively been executed during the test.

### BACKGROUND OF THE INVENTION

1. Field of the Invention

The present invention generally relates to the testing of electronic circuits and, more specifically, to systems of functional testing of smart cards by parallel execution of different scenarios by the card to be tested and by a simulator, associated with the test tool and reproducing the functions (instruction set) of a card.

2. Discussion of the Related Art

FIG. 1 very schematically shows in the form of blocks, a conventional example of a system for functional testing smart cards 1 (CARD) by means of a tester 2 (TESTER) of the type to which the present invention applies. Tester 2 most often is a computer system capable of exchanging data and commands with the smart card 1 to be tested (more generally, with the electronic circuit to be tested), be it with or without contact. The tester functionally comprises a control circuit 21 (CTRL) intended to trigger software instruction sequences (scenarios) both in card 1 to be tested and in a function 22 (VC) simulating a card and forming a virtual card. Simulation function 22 is generally programmed in tester 2, which has its control circuit 21 itself programmed to contain different scenarios according to the applications of the cards to be tested. The representation of FIG. 1 is very simplified, and the tester can in practice be obtained by means of a computer.

The role of the functional test to which the present invention applies includes checking that the card to be tested 1 reacts correctly to the different commands by comparing the states that it provides with those given back by reference simulator 22 which is assumed to be correct. Most often, the test includes placing the card in normal and abnormal situations (software and/or hardware states) to check that it behaves properly.

In practice, the card has a set of instructions and commands which are exploited by programs loaded into a memory of its chip (for example, java applications). The simulator comprises the same set of instructions to be able to execute the same programs, on the tester side.

A problem which is posed is that it is in practice impossible to test all the possible combinations of states and commands. A number of commands and of state sets that the designer considers as critical or representative and to be tested generally has to be selected.

A problem then is to check that the test scenarios have effectively implemented all the steps considered as critical or representative.

A known solution to attempt solving this problem is to check that at the end of the test, all the lines of the software stored in the smart card have been addressed at least once. This amounts to checking along the test whether each line of the program stored in the card is reached by at least one command of at least one scenario. Such a test may be performed by an integrated circuit emulator or simulator.

A disadvantage of this technique is that it does not take into account the card state and especially variables processed by the instructions such as, for example, the balance of an e-purse. Now, in many cases, the card state is important to make sure that the card program is able to properly process specific values (for example, limiting values such as an empty purse or a purse with the maximum balance in an e-purse application).

### SUMMARY OF THE INVENTION

The present invention aims at overcoming all or part of the disadvantages of known test systems and more specifically of systems of functional smart card testing by means of a simulator representing a virtual card.

The present invention also aims, in a smart card test, of controlling that steps comprising commands and states of the card considered as critical or representative have effectively been processed by the test scenarios.

The present invention also aims at providing a solution compatible with current test systems and, especially, generating no structural modification of the test tools.

The present invention also aims at requiring no structural or software modification of the cards to be tested.

To achieve all or part of these objects, as well as others, the present invention provides a method for testing an electronic circuit by parallel execution of a program in the circuit and in a simulator, comprising a step of checking that commands and conditions contained in the simulator have effectively been executed during the test.

According to an embodiment of the present invention, said conditions are states of variables of the simulator.

According to an embodiment of the present invention, the test is considered as complete when all commands and conditions have been reached in the testing.

According to an embodiment of the present invention, a tested electronic circuit is considered as functionally correct if all the commands and conditions have been reached in the testing and if all the responses of the electronic circuit are in accordance with those of the simulator.

The present invention also provides a simulator of an electronic circuit for the testing of other circuits by parallel execution of programs contained in the circuits and in the simulator, execution detection instructions being inserted in commands of the simulator.

According to an embodiment of the present invention, said detection instructions take into account the executed command and a condition on at least one variable of the simulator.

The present invention also provides a system for testing smart cards by parallel execution of a test program in a card to be tested and in a simulator, the simulator comprising means for checking whether instructions and conditions considered as critical or representative of its set of commands are reached during the test.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, very schematically shows in the form of blocks an example of a test system of the type to which the present invention applies; and

FIG. 2 illustrates an embodiment of the test method according to the present invention.

### DETAILED DESCRIPTION

For clarity, only those steps and elements which are useful to the understanding of the present invention have been shown in the drawings and will be described hereafter. In particular, the exchanges between the test system, the virtual card (simulator) and the card to be tested have not been described in detail, the present invention being compatible with conventional systems. Further, the creation of the functional scenarios has not been described in detail, the present invention being here again compatible with conventional systems.

A feature of an embodiment and implementation mode of the present invention is to integrate, in the reference simulator and more specifically in its set of commands, detection instructions intended to make sure that the concerned commands have effectively been executed in the test.

The present invention takes advantage from the fact that the simulator is used in parallel with the card to be tested and receives the same commands from the test device. Thus, checking the execution of commands or of specific procedures in the simulation tool amounts to the same as making sure that they have been executed on the card side. It is thus not necessary to modify the card or its program for the implementation of the present invention.

The action taken by the card and the simulator as a response to these commands belong to the conventional functional test. What matters for the present invention is to detect that specific conditions (command+state) have effectively been achieved in the test.

In practice, the creator of the simulator and of the test device (scenario definition) is not the same as the creator of the card program. Such is in particular the case in the context of applications parameterizable according to the card destination. However, all application programs use the same basic instructions or the same commands (instruction and variable groups) so that it is possible to establish test scenarios implementing the different instructions.

On writing of the program forming the card simulator, the designer determines which commands and conditions (considered as critical or representative) are to be checked. These elements define so-called coverage points corresponding to a program line in the reference simulator associated with a condition of the state of the simulator (and thus of the tested card) at the same time. A coverage point is reached if, in the tests, the reference simulator goes through the line where this instruction is located and the condition on the state is checked.

After, the test device executes scenarios linked to the application which will use different instructions and conditions of the card and of the simulator. The creation of the test scenarios is independent from the introduction of coverage points into the simulator. Thus, it is effectively checked whether all coverage points have been reached by the different test scenarios.

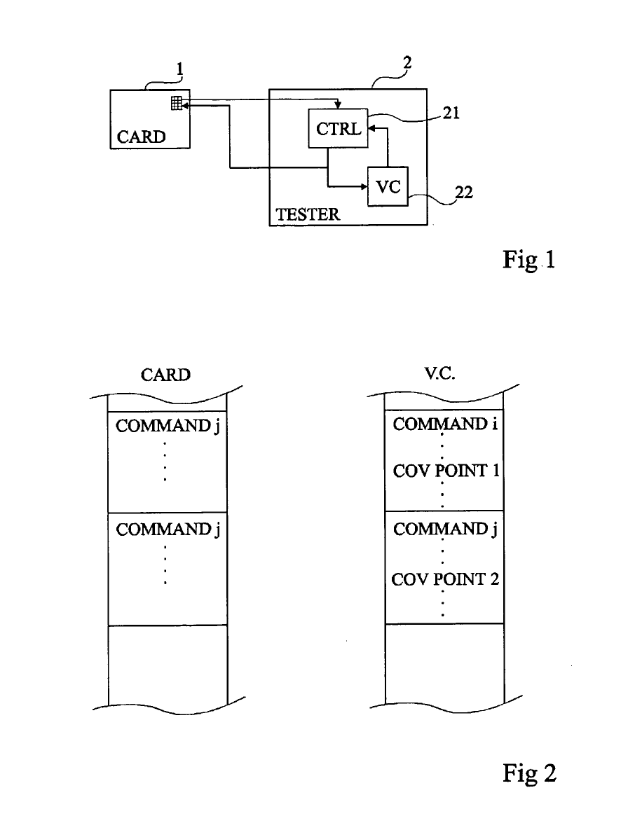

FIG. 2 very schematically illustrates an embodiment of the present invention. It is a program on the reference simulator side (VC or Virtual Card). In several commands (for example 2) COMMANDi and COMMANDj, coverage points are provided, for example, COV POINT1 and COV POINT2. The same commands on the card side (CARD) do not comprise the lines corresponding to the coverage points. When an application executed by the test is sent onto both the card to be tested (1, FIG. 1) and the reference simulator, the latter uses one of the two commands, and the tester then stores that the corresponding coverage point has been reached.

At the end of the test, it is checked whether all the coverage points defined in the reference card have effectively been run through by the test.

On the test device side, the coverage points reached during the test are counted (be it in the form of an event counter or in the form of a table) to be able to check that all the required coverage points have effectively been scanned by the test. Further, the coverage points defined in the simulator are counted to compare the set of reached points with the set of points to be reached.

An advantage of the present invention is that it enables testing all the critical or representative points of a card independently from the application which is executed therein, without this requiring an exhaustive testing of all the instructions and conditions. Only those instructions and conditions which are considered as critical or representative by the designer of the card, and thus of the simulator, will be taken into account.

An advantage of the present invention is that it takes into account not only the execution of a specific instruction in the card but also a condition on its state.

Considering the e-purse example, it is assumed that two conditions on the card balance are critical, because they are close to the maximum balance (BALMAX) or to the minimum balance (BALMIN). In a card credit operation corresponding to a test scenario, the balance (variable BAL) must not exceed the maximum threshold. In a card debit operation which corresponds to another test scenario, the balance must not become lower than the minimum balance. The checkings of these conditions are contained in the programs of the card and of the reference simulator in the form of specific commands comparing the current balance and the current amount with the maximum balance or the minimum balance.

According to an embodiment of the present invention, lines corresponding to coverage points are inserted on the reference simulator side in the corresponding commands by each time adding the condition on the maximum and minimum balance. Thus, on execution of the credit and debit test scenarios, the coverage points will be considered as reached only if the tests are performed with increment or decrement amounts respectively leading to balance values compatible with the expected thresholds.

Of course, the present invention is likely to have various alterations, improvements, and modifications which will readily occur to those skilled in the art. In particular, although the present invention has been more specifically described in relation with an application to smart cards of e-purse type, it more generally applies to any electronic circuit test in which a reference circuit executing in parallel the same instructions as the circuit to be tested is used. Further, the implementation of the present invention is within the abilities of those skilled in the art based on the functional indications given hereabove, especially as concerns the selection of the instructions and conditions considered as critical or representative and having to be scanned in functional tests.

As an example of implementation, a table in which each line corresponds to a coverage point is provided. For example, each line is determined either by its rank in the table, or by a logic identifier selected by the designer of the simulator. At the beginning of the execution by the test device, no line is marked. A coverage point may be instantiated by an instruction which marks a given line in the table, referenced either by its rank, or by a logic identifier. This instruction is prefixed by the condition on the current state of the simulator. Thus, a table line will be marked if and only if the corresponding coverage point is reached.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for testing an electronic circuit by parallel execution of a program in the circuit and in a simulator, comprising a step of checking that commands and conditions contained in the simulator have effectively been executed during the test.

2. The method of claim 1, wherein said conditions are states of variables of the simulator.

3. The method of claim 1, wherein the test is considered as complete when all commands and conditions have been reached in the testing.

4. The method of claim 1, wherein a tested electronic circuit is considered as functionally correct if all the commands and conditions have been reached in the testing and if all the responses of the electronic circuit are in accordance with those of the simulator.

5. A simulator of an electronic circuit for the testing of other circuits by parallel execution of programs contained in the circuits and in the simulator, wherein execution detection instructions are inserted in commands of the simulator.

6. The circuit of claim 5, wherein said detection instructions take into account the executed command and a condition on at least one variable of the simulator.

7. A system for testing smart cards by parallel execution of a test program in a card to be tested and in a simulator, wherein the reference simulator comprises means for checking whether instructions and conditions considered as critical or representative of its set of commands are reached during the test.
